(19) United States
(12) Patent Application Publication
(10) Pub. No.: US 2014/0308097 A1
(43) Pub. Date: Oct. 16, 2014

(54) FORKLIFT, AUTOMATIC WAREHOUSE USING SAME, AND CARGO HANDLING METHOD USING FORKLIFT

(71) Applicant: Yukihiro Akahori, Inuyama-shi (JP)

(72) Inventor: Yukihiro Akahori, Inuyama-shi (JP)

(73) Assignee: MURATA MACHINERY, LTD., Kyoto-shi, Kyoto (JP)

(21) Appl. No.: 14/115,156

(22) PCT Filed: Apr. 27, 2012
(86) PCT No.: PCT/JP2012/061337

§ 371 Date: Nov. 25, 2013

(30) Foreign Application Priority Data
Jun. 30, 2011 (JP) 2011-145634

(51) Int. Cl. B66F 9/075; B65G 1/06

(52) U.S. Cl. CPC B66F 9/075; B65G 1/065
USPC 414/277; 187/222; 414/800

(57) ABSTRACT

A forklift truck includes a lateral pair of side frames, a rear frame connecting rear end portions of the side frames, and a fork member disposed in a space between the pair of side frames in plan view so as to be lifted and lowered. The forklift truck includes a wheel unit provided in a leading end portion of each of the side frames and a central portion of the rear frame, the wheel unit including a steering motor, a running motor, and a driving wheel, and a battery provided in a central portion of each of the side frames.

### BACKGROUND OF THE INVENTION

1. Field of the Invention

The present invention relates to a forklift truck configured to make a spin turn and an automated warehouse and a load handling method using the same.

2. Description of the Related Art

Forklift trucks are used for handling loads in warehouses. For example, the applicant has proposed a forklift truck including one wheel unit including a steering motor, a running motor, and a driving wheel, one caster wheel, and two following wheels (JP 2008-175674A). Such a forklift truck, however, has a large turning radius, and thus requires a path having a large width in a warehouse.

### SUMMARY OF THE INVENTION

Preferred embodiments of the present invention provide a compact forklift truck configured to make spin turns, so as to enable articles to be handled even if a width of a path in an automated warehouse is narrow.

A preferred embodiment of the present invention provides a forklift truck including a lateral pair of side frames, a rear frame connecting rear end portions of the side frames, and a fork member disposed in a space between the pair of side frames in plan view so as to be lifted and lowered, wheel units provided respectively in a leading end portion of each of the side frames and a central portion of the rear frame, the wheel units including respectively steering motors, running motors, and driving wheels, and batteries provided in respective central portions of the side frames.

Another preferred embodiment of the present invention provides an automated warehouse including a lateral pair of racks that store articles including pillars and shelf supports; a path between the racks; and the forklift truck according to the above-described preferred embodiment of the present invention, wherein the pillars of the racks are disposed at positions retracted farther back from the path than leading ends of the shelf supports, and the forklift truck is configured to make spin turns using the path and portions of spaces in the racks in such a way that a portion of the forklift truck is located inward of the leading ends of the shelf supports in the racks.

A further preferred embodiment of the present invention provides a load handling method using a forklift truck, including, in an automated warehouse including a lateral pair of racks that store articles, the racks including pillars and shelf supports, a path between the racks; and the forklift truck according to the above-described preferred embodiment of the present invention, the pillars of the racks being disposed at positions retracted farther back from the path than leading ends of the shelf supports, the load handling method including: transferring articles to and from the racks by causing the forklift truck to make spin turns using the path and portions of spaces in the racks in such a way that a portion of the forklift truck is located inward of the leading ends of the shelf supports in the racks.

According to a preferred embodiment of the present invention, all of the three wheel units include the steering motor, and therefore may make spin turns. Also, because batteries are provided at the central portion of the side units, a more compact forklift truck may be obtained compared with when the battery is provided on the rear frame. Also, with the use of this forklift truck, an automated warehouse configured to perform storage and retrieval in a narrow path may be obtained because the forklift truck may make spin turns using portions of the space inside the rack. In the present specification, the descriptions related to the forklift truck also directly apply to the automated warehouse and the load handling method, and the descriptions related to the automated warehouse also directly apply to the load handling method.

Preferably, in respective wheel units of the side frames, inner side portions of the steering motors are fixed to the wheel units, outer side portions thereof are provided rotatably to the inner side portions, inner side portions of the running motors are attached to fixed shafts provided so as to bridge two supporting members attached to the outer side portions of the steering motors, outer side portions of the running motors and the driving wheels are attached rotatably to the supporting members, and portions of the driving wheels are housed in hollow portions of the inner side portions of the steering motors. This allows a portion of the driving wheel to be housed in the space in the height direction of the steering motor, thus reducing the height of the wheel unit. Accordingly, the height of the side frames from the floor may be reduced, thus reducing the height of the shelf supports of each rack in and from which the forklift truck performs storage and retrieval.

Preferably, the forklift truck has a vehicle body length longer than a width of the path that is defined by an interval between the lateral pair of racks, the side frames and the rear frame of the forklift truck have top surfaces lower than bottom surfaces of the shelf supports, a panel standing upright from the rear frame is provided at a position of the rear frame toward the fork member, and the forklift truck makes spin turns with the side frames and the rear frame being located below the shelf supports, and turning centers of the forklift truck being displaced from a center of the path toward one of the racks to which articles are transferred.

By making the top surfaces of the side frames and the rear frame of the forklift truck lower than the bottom surfaces of the shelf supports, these frames and the shelf supports may be prevented from interfering with one another. Further, the interference between the frames and the pillars may be prevented by retracting the pillars of the racks from the leading ends of the shelf supports so as to be outside the spin turn range of the forklift truck. Because the top surface of the panel is higher than the bottom surfaces of the shelf supports, the panel may be prevented from being located inward of the leading ends of the shelf supports in the racks by causing the forklift truck to make spin turns with the turning centers being displaced from the center of the path toward the rack to which an article is transferred.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view of a forklift truck according to a preferred embodiment of the present invention.

FIG. 2 is a side view showing relevant portions of the forklift truck and an automated warehouse.

FIG. 3 is a vertical cross-sectional view of a wheel unit used in a preferred embodiment of the present invention.

FIG. 4 schematically shows operations of the forklift truck according to a preferred embodiment of the present invention in the automated warehouse.

### DETAILED DESCRIPTION OF THE PREFERRED EMBODIMENTS

The following describes preferred embodiments of the present invention. The scope of the present invention is based on the claims, and is intended to be determined in accordance with the understanding of a person skilled in the art with reference to the description of the present invention and related art in the field of the present invention.

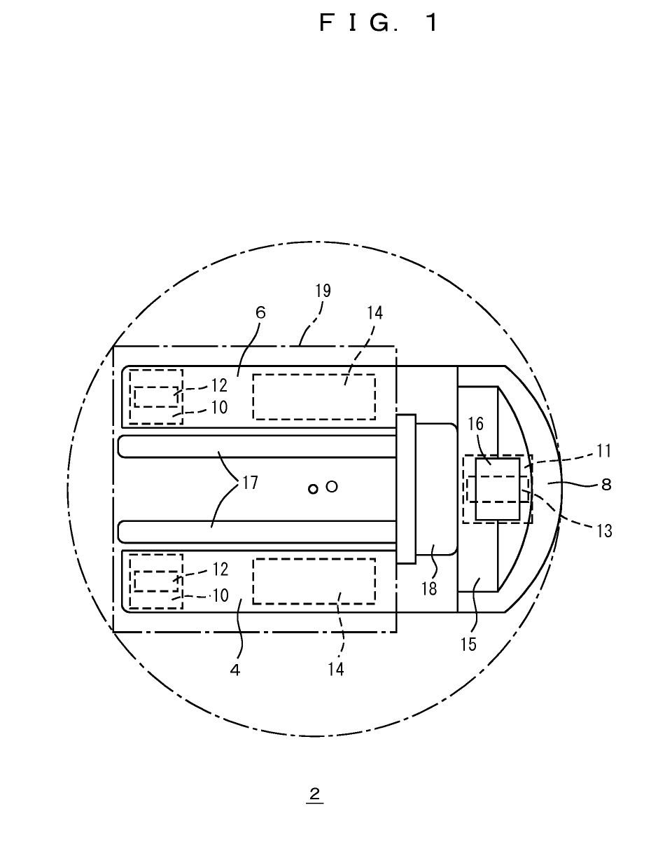

FIGS. 1 to 4 show a forklift truck 2 and an automated warehouse 20 according to preferred embodiments of the present invention. The forklift truck 2 includes a lateral pair of side frames 4 and 6, and a rear frame 8 connecting the rear end portions of the side frames 4 and 6. In the forklift truck 2, a wheel unit 10 is provided at the leading end of each of the side frames 4 and 6, and the same wheel unit 11 is provided also at the central portion of the rear frame 8. The wheel units 10 and 11 each include a running motor and a steering motor, and reference numeral 12 and 13 denote driving wheels. Further, each of the side frames 4 and 6 is provided with a battery 14 at the central portion thereof.

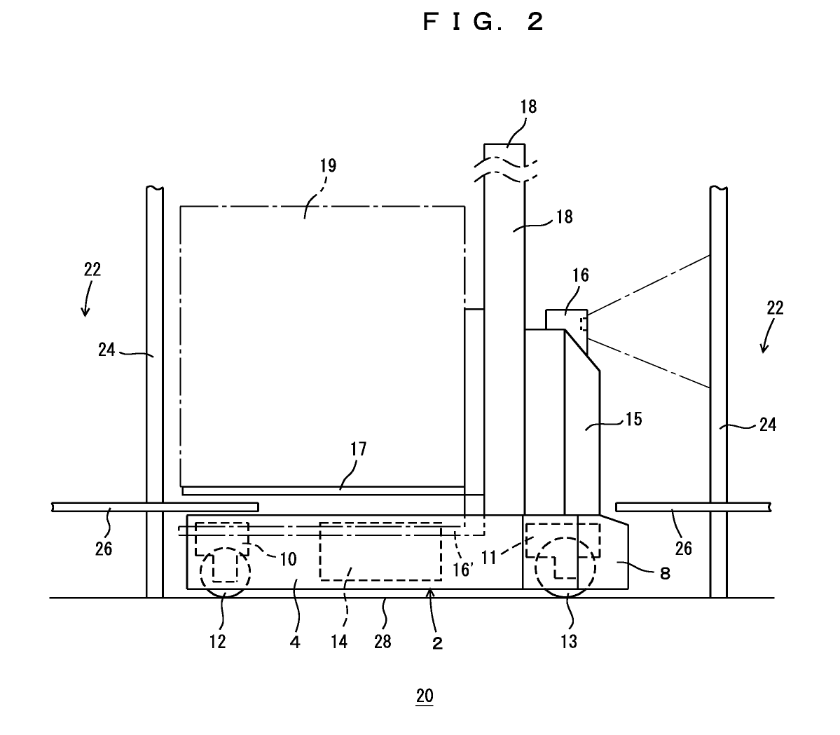

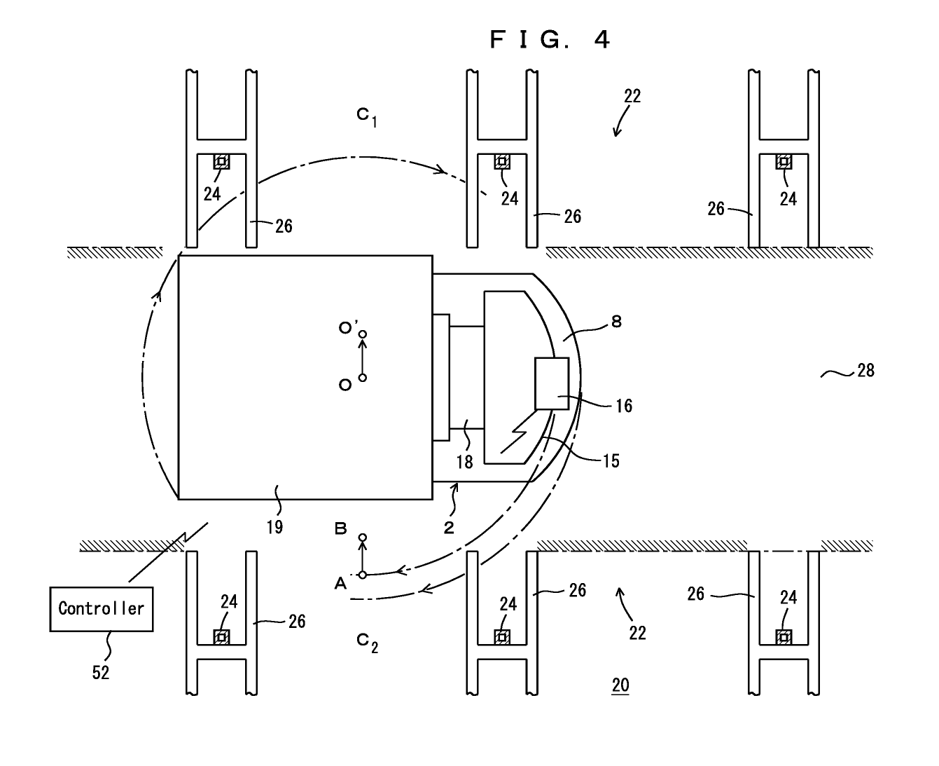

At the rear frame 8 is provided a vertically upright panel portion 15, above which is provided a control unit 16. Images of the surrounding area are captured by a CCD camera (not shown) or the like, and the current position is determined by image recognition. Also, the storage and retrieval operation is automatically performed by the forklift truck in the automated warehouse 20 through communication with a controller 52 on the ground side shown in FIG. 4. Instead of using image recognition, the current position may be recognized by measuring the distance from a reference point by a rotatable laser range finder. Alternatively, the forklift track may run following a guiding line provided on the path. Furthermore, the panel portion 15 may be provided with an RFID reader, and RFIDs or the like attached, for example, to the leading ends of the shelf supports of the racks may be read. Reference numeral 17 denotes a fork, which is lifted and lowered by an elevating drive 18 disposed so as to bridge the side frames 4 and 6. The fork 17 is disposed so as to fit into the space between the side frames 4 and 6 in plan view, and transfers articles to and from the racks 22 of the automated warehouse 20 shown in FIG. 2 by lifting and lowering a pallet 19.

The forklift truck 2 includes three driving wheels 12 and 13, and may independently steer the driving wheels 12 and 13. Thus, the forklift truck 2 may make a spin turn, traversing, and skewing and may also perform them simultaneously. To achieve this, for example, the amount of operation for making a spin turn and the amount of operation for traversing or the like may be applied to the wheel units 10 and 11 so that these amounts are combined together. The chain line in FIG. 1 indicates the turning range when the forklift truck 2 makes a spin turn, and 0 denotes the turning center.

FIG. 2 is a view of the forklift truck 2 performing storage and retrieval on a path 28 of the automated warehouse 20. The control unit 16 recognizes the current position by capturing images of the surrounding area, and controls the wheel units 10 and 11 and the elevating drive 18. The automated warehouse 20 includes a lateral pair of racks 22. Reference numeral 24 denotes a pillar, which supports the rack 22, and reference numeral 26 denotes a shelf support, on which the pallet 19 is stored. The space between the leading ends of the shelf supports 26 serves as the path 28. The side frames 4 and 6 and the rear frame 8 are at positions lower than the bottom surfaces of the shelf supports 26, and the pillars 24 are disposed inward of the shelf supports 26 in the racks 22. Consequently, the side frames 4 and 6 and the rear frame 8 may enter the inside of the racks 22. Further, in the case of article drop off, the fork 17 is at a position higher than the top surfaces of the shelf supports 26. In the case of article pickup, the fork 17 is at a position lower than the bottom surfaces of the shelf supports 26. Note that the top surface of the rear frame 8 may be higher than the shelf supports 26, the racks 22 may have a height corresponding to one cell opening or a height corresponding to a plurality of cell openings, and the forklift truck 2 may transfer the pallet 19 to and from, for example, a station and a conveyor, in addition to the racks 22.

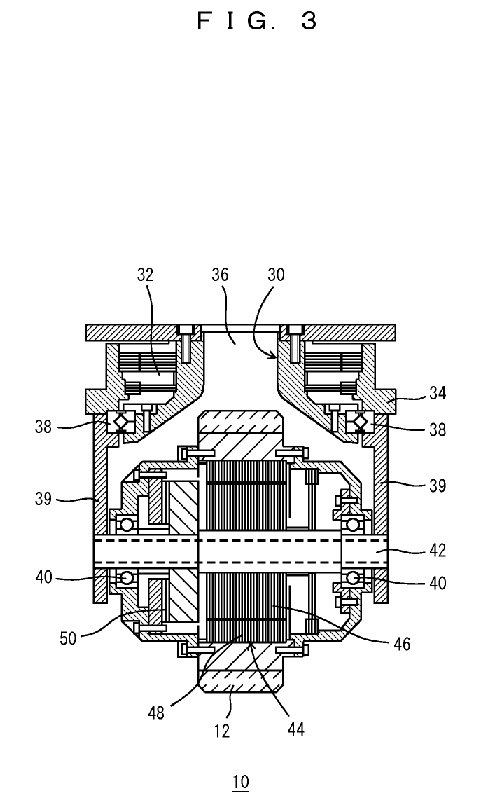

FIG. 3 shows the structure of the wheel unit 10. Although the wheel unit 11 preferably has the same structure, the reduction of height from the floor is not of great importance for the wheel unit 11. Thus, with the wheel unit 11, a portion of the driving wheel 13 does not need to be housed in the steering motor 30. Reference numeral 30 denotes a steering motor, which preferably includes a fixed inner side portion 32 and a movable outer side portion 34. The steering motor 30 preferably has the shape of a hollow cylinder, and includes a hollow portion 36 inside the inner side portion 32. Also, the inner side 32 and the outer side 34 are connected via a bearing 38. For example, a lateral pair of supporting members 39 are attached to the outer side portion 34, and a fixed shaft 42 is provided so as to bridge the supporting members 39. The inner side 46 of the running motor 44 is attached to the fixed shaft 42, and the outer side 48 is rotatably supported by the fixed shaft 42 via a bearing 40. Also, the driving wheel 12 is attached to the outer side 48, and these two components rotate together. Reference numeral 50 denotes a brake. As shown in FIG. 3, a portion in the height direction of the driving wheel 12 is housed in the hollow portion 36 of the inner side 32, thus reducing the height of the wheel unit 10 from the floor by an amount corresponding to the overlap between the hollow portion 36 and the driving wheel 12. Accordingly, the heights of the side frames 4 and 6 and the rear frame 8 from the floor may be reduced, thus allowing the shelf supports 26 to be disposed at low positions.

FIG. 4 shows an operation of the forklift truck 2 performed in the automated warehouse 20. Reference sign 0 denotes the turning center, and the chain lines indicate the turning ranges of the pallet 19, the rear frame 8, and the panel portion 15. The path 28 has a width that is shorter than the vehicle body length of the forklift truck 2. Reference signs C1 and C2 denote opposing cells. Here, the pallet 19 is dropped off in the cell C1, but the operation is performed in the same manner also when the pallet 19 is picked up from the cell C1.

The frames 4, 6, and 8 are at positions lower than the shelf supports 26, and thus it is another pallet and the pillars 24 that interfere with each other. The panel portion 15 also interferes with the shelf supports 26. Then, making a spin turn about the turning center O in FIG. 4 enables storage and retrieval using the path 28 having a width smaller than the vehicle body length of the forklift truck 2. However, in the trajectory shown in FIG. 4, the panel portion 15 partly enters the cell C2. In the case of avoiding this, the transfer may be started in a state in which the forklift truck 2 is brought further toward the cell C1, utilizing the fact that the frames 4 and 6 and 8 have a low height relative to the floor and thus do not interfere with the shelf supports 26. Alternatively, by starting a spin turn from the turning center O in FIG. 4 and causing the forklift truck 2 to retract toward the turning center O′ side simultaneously with the spin turn, the position at which the panel portion 15 enters furthest into the cell C2 may be moved from A (inside the cell C2) to B (outside the cell C2 and inside the path 28) in FIG. 4. In either case, the turning center of the forklift truck 2 passes through a position, for example, the position O′ that is displaced toward the cell C1, where transfer is performed, in the running direction of the path 28 as viewed from the center line.

The above preferred embodiment achieves the following advantageous effects.
(1) A compact, low-floor spin forklift truck 2 configured to make a spin turn is provided.
(2) The use of the forklift truck 2 enables storage and retrieval to and from the racks 22 by using the path 28 having a narrow width.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

### LIST OF REFERENCE NUMERALS

2 Forklift truck

4,6 Side frame

8 Rear frame

10,11 Wheel unit

12,13 Driving wheel

14 Battery

15 Panel portion

16 Control unit

17 Fork

18 Elevating drive

19 Pallet

20 Automated warehouse

22 Rack

24 Pillar

26 Shelf support

28 Path

30 Steering motor

32 Inner side portion

34 Outer side portion

36 Hollow portion

38, 40 Bearing

39 Supporting member

42 Fixed shaft

44 Running motor

46 Inner side portion

48 Outer side portion

50 Brake

52 Controller

O Turning center

C₁, C₂ Cell

1-6. (canceled)

7. A forklift truck comprising:
a lateral pair of side frames;
a rear frame connecting rear end portions of the side frames;
a fork member disposed in a space between the pair of side frames in plan view so as to be lifted and lowered;
wheel units provided respectively in a leading end portion of each of the side frames and a central portion of the rear frame, the wheel units including respectively steering motors, running motors, and driving wheels; and
batteries provided in respective central portions of the side frames.

8. The forklift truck according to claim 7, wherein, respective wheel units of the side frames, inner side portions of the steering motors are fixed to the wheel units, outer side portions thereof are provided rotatably to the inner side portions, inner side portions of the running motors are attached to fixed shafts provided so as to bridge two supporting members attached to the outer side portions of the steering motors, outer side portions of the running motors and the driving wheels are attached rotatably to the supporting members, and portions of the driving wheels are housed in hollow portions of the inner side portions of the steering motors.

9. An automated warehouse comprising:
a lateral pair of racks that store articles and including pillars and shelf supports;
a path between the racks; and
the forklift truck according to claim 7; wherein
the pillars of the racks are disposed at positions retracted farther back from the path than leading ends of the shelf supports; and
the forklift truck is configured to make spin turns using the path and portions of spaces in the racks such that a portion of the forklift truck is located inward of the leading ends of the shelf supports in the racks.

10. The automated warehouse according to claim 9, wherein
the forklift truck has a vehicle body length longer than a width of the path that is defined by an interval between the lateral pair of racks;
the side frames and the rear frame of the forklift truck have top surfaces lower than bottom surfaces of the shelf supports;
a panel standing upright from the rear frame is provided at a position of the rear frame toward the fork member; and
the forklift truck makes spin turns with the side frames and the rear frame being located below the shelf supports, and turning centers of the forklift truck being displaced from a center of the path toward one of the racks to which articles are transferred.

11. A load handling method using a forklift truck, in an automated warehouse including a lateral pair of racks that store articles, the racks including pillars and shelf supports, a path between the racks, and the forklift truck according to claim 7, the pillars of the racks being disposed at positions retracted farther back from the path than leading ends of the shelf supports, the load handling method comprising:
transferring articles to and from the racks by causing the forklift truck to make spin turns using the path and portions of spaces in the racks such that a portion of the forklift truck is located inward of the leading ends of the shelf supports in the racks.

12. The load handling method using a forklift truck according to claim 11, wherein
the forklift truck has a vehicle body length longer than a width of the path that is defined by an interval between the lateral pair of racks;
the side frames and the rear frame of the forklift truck have top surfaces lower than bottom surfaces of the shelf supports;
a panel standing upright from the rear frame is provided at a position of the rear frame toward the fork member; and
the forklift truck makes spin turns with the side frames and the rear frame being located below the shelf supports, and turning centers of the forklift truck being displaced from a center of the path toward one of the racks to which articles are transferred.
